(19) United States
(12) Patent Application Publication
(10) Pub. No.: US 2020/0009521 A1
(43) Pub. Date: Jan. 9, 2020

(54) SYSTEMS AND METHODS FOR CONTROLLING BED AGGLOMERATION IN FLUIDIZED-BED BOILERS

(71) Applicant: THE BABCOCK & WILCOX COMPANY, Barberton, OH (US)

(72) Inventors: Prasanna SESHADRI, Akron, OH (US); James F. DeSELLEM, Salineville, OH (US); Mandar GADGIL, Akron, OH (US); Thomas J. Flynn, N. Canton, OH (US); Laura M. McDermitt, Wadsworth, OH (US)

(21) Appl. No.: 16/026,544

(22) Filed: Jul. 3, 2018

(51) Int. Cl. B01J 8/24; B01J 20/30; B01J 23/745; B01J 8/18

(52) U.S. Cl. CPC B01J 8/24; B01J 20/3028; B01J 2208/00681; B01J 8/1809; B01J 23/745

(57) ABSTRACT

The present disclosure relates to fluidized-bed boilers and methods for controlling bed agglomeration that can occur when biomass containing high amounts of phosphorus is used as fuel. Iron-containing compounds, such as iron oxide, are added to the fluidized bed to tie up the phosphorus in a form that will not react under typical operating conditions for fluidized-bed boilers.

### BACKGROUND

The present disclosure relates to systems and methods for controlling, reducing, and/or preventing bed agglomeration in fluidized-bed boilers. In particular, these systems and methods are useful when biomass fuels containing high amounts of phosphorus are used.

During combustion, the chemical energy in a fuel is converted to thermal heat inside the furnace of a boiler. The thermal heat is captured through heat-absorbing surfaces in the boiler to produce steam.

Solid biomass waste byproducts are increasingly being used as fuel for power generation, since biomass is a renewable energy source. However, some agricultural biomass fuels have significantly higher amounts of elements such as phosphorus (P), sulfur (S), and alkalis such as potassium (K) and sodium (Na), compared to wood-based biomass. Phosphorus, potassium and sodium have moderate to high vapor pressures in the reducing zone of the boiler, and hence, can have a strong tendency to promote bed sintering and agglomeration by forming vapor phase species which will eventually coat bed particles forming a sticky layer. For fuels rich in alkalis (Na and K), calcium (Ca), silica (Si), and phosphorus (P), such as agricultural waste and residues, etc., the formation of metal phosphates (such as potassium phosphate and calcium phosphate) and alkali silicates (such as sodium silicate) can result in lower ash melting temperatures, which in turn can promote rapid sintering or agglomeration of bed particles. Bed agglomeration can limit the use of such agricultural biomass fuels for heating and power generation.

It would be desirable to provide systems and methods that can be used to derive useful energy from such biomass waste byproduct.

### BRIEF DESCRIPTION

The present disclosure relates to systems and methods for controlling bed agglomeration in fluidized-bed boilers, which may occur when agricultural biomass fuels high in phosphorus and alkali content are used. An iron-containing compound is added to the fluidized bed during combustion. Phosphorus released from the biomass reacts with the iron, forming iron phosphates that are less reactive and have a much higher melting temperature than typical fluidized bed operating conditions. This also results in a net increase in the bed agglomeration temperature.

Disclosed herein in various embodiments are methods for reducing bed agglomeration in a fluidized-bed boiler when a biomass fuel is combusted, comprising: adding at least one iron-containing compound to the fluidized bed of the fluidized-bed boiler.

The at least one iron-containing compound may be an iron (II) oxide; an iron (III) oxide; an iron (II) halide; an iron (III) halide; an iron (III) iodate; or an iron (II) carbonate.

The at least one iron-containing compound can be water soluble, and added in the form of a solution. Alternatively, the at least one iron-containing compound can be water insoluble, and be added in the form of a suspension or emulsion.

The biomass fuel may be corn stover, switch grass, miscanthus, or hybrid poplar. The biomass fuel may have a moisture content of about 30% to about 60%.

The fluidized-bed boiler may be operated at a temperature of about 1200° F. to about 2000° F. (about 648° C. to about 1093° C.). In particular embodiments, the air/fuel stoichiometry in the primary zone of the fluidized-bed boiler is less than 1, and in some embodiments the air/fuel stoichiometry is about 0.4 to about 0.5. The fluidized bed may comprise silica, alumina, or calcium.

In some embodiments, the at least one iron-containing compound may be added to the fluidized bed in an amount of up to 12 wt % of the biomass fuel. In other embodiments, the at least one iron-containing compound is added to the fluidized bed in an amount of up to 3 moles per mole of (sodium oxides+potassium oxides+phosphorus oxides). In yet other embodiments, the at least one iron-containing compound may be added to the fluidized bed in an amount of up to 3 moles per mole of (Na₂O+K₂O+P₂O₅).

The at least one iron-containing compound can be mixed together with the biomass fuel, and thus added to the fluidized bed of the fluidized-bed boiler concurrently with the biomass fuel. Alternatively, the at least one iron-containing compound can be injected through ports at or adjacent to a biomass fuel feed point. In yet other embodiments, the at least one iron-containing compound can be injected into a bottom of the fluidized bed.

The at least one iron-containing compound can be added to a fluidized-bed boiler containing kaolin.

These and other non-limiting aspects of the present disclosure are discussed further herein.

### BRIEF DESCRIPTION OF THE DRAWINGS

The following is a brief description of the drawings, which are presented for the purposes of illustrating embodiments disclosed herein and not for the purposes of limiting the same.

FIG. 1 diagrammatically shows an illustrative bubbling fluidized-bed (BFB) boiler of a known design.

FIG. 2 is a cross-sectional perspective view of a fuel feeder, which can be used to feed both the biomass fuel and to inject the additive into the fluidized-bed boiler.

FIG. 3 is a schematic diagram of a fluidized-bed boiler illustrating some further aspects of the present disclosure.

FIG. 4 is a graph of bed agglomeration temperature versus the amount of iron oxide injected into the bed. The y-axis is in degrees Celsius, and runs from 800° C. to 950° C. at intervals of 25° C. The x-axis is moles of iron oxide per moles of oxides of (Na+K+P), and runs from 0 to 3 at intervals of 0.5.

FIG. 5 is a bar graph of wt % of phosphorus in the fluidized bed versus the amount of iron oxide injected into the bed. The y-axis is in wt %, and runs from 0.00 to 0.30 at intervals of 0.10. The bars are, running from left to right, baseline (i.e. 0), 4 wt % Fe, and 8 wt % Fe (by weight of the fuel).

### DETAILED DESCRIPTION

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The present disclosure may be understood more readily by reference to the following detailed description of desired embodiments and the examples included therein. In the following specification and the claims which follow, reference will be made to a number of terms which shall be defined to have the following meanings.

The singular forms “a,” “an,” and “the” include plural referents unless the context clearly dictates otherwise.

The term “comprising” is used herein as requiring the presence of the named components/steps and allowing the presence of other components/steps. The term “comprising” should be construed to include the term “consisting of”, which allows the presence of only the named components/steps.

Numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values). The endpoints of the ranges and any values disclosed herein are not limited to the precise range or value; they are sufficiently imprecise to include values approximating these ranges and/or values.

The modifier “about” used in connection with a quantity is inclusive of the stated value and has the meaning dictated by the context. When used in the context of a range, the modifier “about” should also be considered as disclosing the range defined by the absolute values of the two endpoints. For example, the range of “from about 2 to about 10” also discloses the range “from 2 to 10.” The term “about” may refer to plus or minus 10% of the indicated number. For example, “about 10%” may indicate a range of 9% to 11%, and “about 1” may mean from 0.9-1.1.

Some terms used herein are relative terms. For example, the terms “upper” and “lower” are relative to each other in location, i.e. an upper component is located at a higher elevation than a lower component. The terms “inlet” and “outlet” are relative to a fluid flowing through them with respect to a given structure, e.g. a fluid flows through the inlet into the structure and flows through the outlet out of the structure.

To the extent that explanations of certain terminology or principles of the boiler and/or steam generator arts may be necessary to understand the present disclosure, the reader is referred to Steam/its generation and use, 42nd Edition, edited by G. L. Tomei, Copyright 2015, The Babcock & Wilcox Company, ISBN 978-0-9634570-2-8, the text of which is hereby incorporated by reference as though fully set forth herein.

Conventionally, pulverized coal has been used as fuel for boilers for power generation. However, due to concerns with CO₂ emissions and a desire to move towards renewable energy sources, the usage of biomass has continuously grown. Biomass is considered CO₂ neutral. Fluidized-bed boilers, such as bubbling fluidized-bed boilers or circulating fluidized-bed boilers, are particularly suited to biomass fuels due to their flexibility in operation over a wide range of fuel properties.

Generally speaking, a fluidized-bed boiler includes a bed formed from a stacked height of solid particles. A fluidization gas distribution grid, such as an open bottom system or a flat floor system, is located beneath the bed. An open bottom system is characterized by widely spaced distribution ducts on which are mounted air bubble caps for distributing fluidizing gas (typically air) under pressure to fluidize the bed. In a flat floor system, the distribution ducts form the floor of the boiler. At sufficient gas velocities, the solid particles exhibit liquid-like properties. In a bubbling fluidized-bed boiler, there is an obvious bed level and a distinct transition between the bed and the space above. In a circulating fluidized-bed boiler, the gas velocity is sufficient for the bed particles to blow out of the furnace. The bed particles are subsequently captured/separated from the gas, and then recycled back to the furnace.

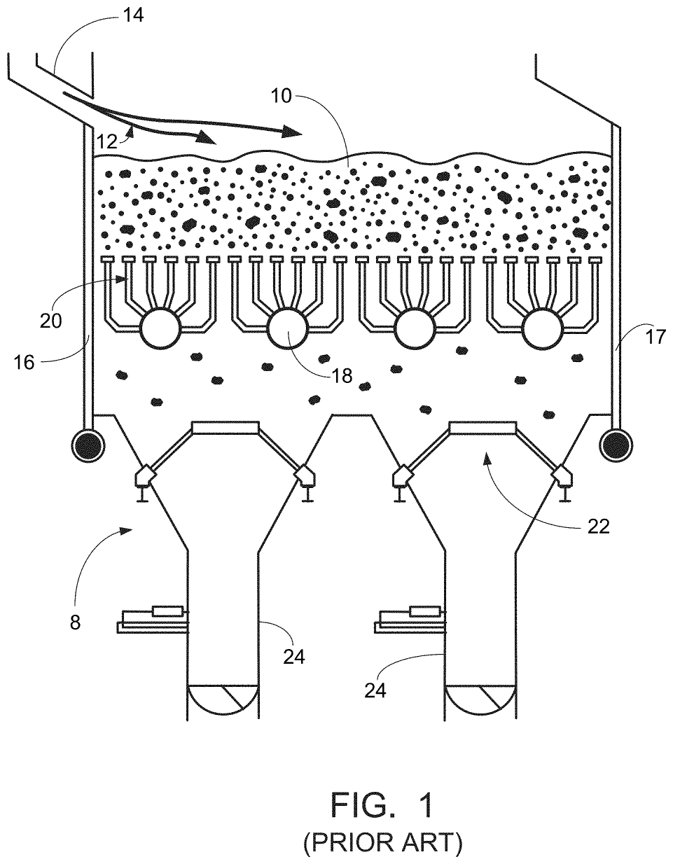

FIG. 1 illustrates a illustrative bubbling fluidized-bed (BFB) boiler 8 of a known design (available from The Babcock & Wilcox Company, Barberton, Ohio, USA). This design includes a bubbling bed 10 onto which fuel 12 is delivered via a feeder 14. The fluidized bed 10 suitably comprises solid particles such as, for example, sand. A gas-tight furnace flue (only the lower portion of which is shown) includes gas-tight tube walls 16, 17 made up of tubes through which water flows to cool the walls. A fluidizing gas, such as air, is introduced into the bubbling bed 10 through ducts 18, and spaced-apart bubble caps 20 facilitate removal of large tramp material. In an underbed ash removal system 22, tramp material moves downward and cools before being removed through bottom hoppers 24 onto a suitable conveyor system or the like (not shown). Heat from combustion on the fluidized bed 10 heats water in the wall tubes 16, 17 which may drive a steam generator or other useful work. In some embodiments, water in the tube walls 16, 17 flows in a closed-loop recirculation path (usually including a make-up water line). The feeder 14 may pass through a non-water cooled refractory furnace wall (e.g., a brick furnace wall) rather than through tube wall 16 as in the illustrative embodiment of FIG. 1, or through any other type of boiler wall. It is contemplated for the furnace wall through which the feeder 14 passes to include additional features such as thermal insulation material, an outer casing, or so forth.

Traditionally, wood-based biomass sources were used for fuel, but today other types of biomass fuel sources are also being used. Newer biomass fuels are mainly agriculture-based, and can include waste products such as corn stover (including by-products of corn stover utilization to produce ethanol) or specially cultivated, short-rotation energy crops such as switchgrass, miscanthus and hybrid poplar. These agriculture-based biomass fuels are considered low-grade fuels because they have higher moisture content (e.g. about 30% to about 60%) and higher ash content. Another common factor among these agriculture-based biomass materials is that they have significantly higher amounts of phosphorus (P), sulfur (S), and alkali elements such as potassium (K) and sodium (Na), as compared to wood-based biomass materials.

During the combustion process, due to their moderate to high vapor pressures, phosphorus, potassium and sodium will have a strong tendency to promote bed sintering and agglomeration by forming vapor phase species which will eventually coat the bed particles and form a tacky or sticky layer. In addition, the formation of certain metal phosphates (such as potassium phosphate and calcium phosphate) and alkali silicates (such as sodium silicate) can result in lower ash melting temperatures, which also promotes rapid sintering or agglomeration of bed particles.

It is thus desirable to control the reaction of gas phase species of P, Na and K with the bed material so as to lower bed agglomeration. This will also help reduce the rate at which the fluidized bed needs to be drained and new inventory needs to be added, thereby reducing the operating cost of the fluidized-bed boiler.

Agglomeration or sintering of the fluidized bed particles is a threshold phenomenon. Agglomeration or sintering is a function of primarily four factors: temperature, composition, particle size, and contact duration. Two different mechanisms for agglomeration or sintering of particles can occur. Typically, fluidized bed particles can consist of primarily silica (sand), alumina (calcined flint) or calcium (limestone). When alkaline constituents (e.g. sodium or potassium) deposit on the surface of the bed particles, the surface can become “tacky” due to the formation of areas of low-melting eutectic compounds on the surface e.g., Si—Ca—K. If the particle surfaces become tacky, the particles can stick together. This mechanism of bonding is typically described as sintering. Other factors contribute to the sintering mechanism. The temperature of the environment strongly influences the sintering process. If the operating temperature is below the corresponding eutectic temperature for the concentrations of species at the surface, then the surface will remain “hard”, and sintering will be less likely to occur. If the bed particles are allowed to remain in contact with each other for prolonged periods of time at stagnant conditions, sintering will be promoted. Smaller particles tend to sinter more readily, and are more difficult to break apart with agitation or fluidization. If the bed operating temperature is significantly above the eutectic point, even large particles that only briefly come into contact with each will sinter. If the operating temperature is closer to (or in some cases less than) the eutectic temperature, but the particles are allowed to contact each other under stagnant conditions (e.g. part-load operation overnight), the particles can also sinter, and will become difficult to separate when one attempts to re-fluidize the bed.

In the other mechanism of agglomeration, if the entire surface of the particles becomes completely coated with low-melting eutectic compounds, the coating can serve as interstitial “glue” and particles will agglomerate. The best approach to control bed agglomeration of this mechanism is to purge the bed material to control the total concentration of agglomerating species below a threshold level in the bed (e.g. 5% of bed weight).

Additional calcium has previously been added to fluidized beds to capture phosphorus in the form of calcium potassium phosphate. Calcium potassium phosphate has a higher melting point than potassium phosphate, and it is claimed that it will not melt at the bed operating temperature. However, fluidizing beds typically operate in reducing conditions (i.e. high carbon monoxide), which will cause the calcium potassium phosphate to release gas phase phosphorus. Next, calcium will preferentially react with sulfur when sulfur is present, which increases the amount calcium that must be added. Finally, calcium is known to catalyze NOx generation, which is also undesirable.

It should also be kept in mind that the operating conditions in the furnace of a fluidized-bed boiler when biomass fuels are used are significantly different from operating conditions when pulverized coal is used.

Pulverized coal furnaces generally operate at temperatures greater than 3000° F. (1649° C.). At 3000° F., virtually all of the alkali (Na, K) or phosphorus in the coal ash vaporizes into the gas phase. In contrast, the fluidized-bed boilers of the present disclosure typically operate at temperatures of about 1200° F. to about 2000° F. (about 648° C. to about 1093° C.). At 1550° F., only select Na and K compounds will decompose; therefore, the concentration of these alkali species in the gas phase is lower and the driving force (concentration gradient) for their capture is also lower. This difference in concentration of Na, K, and P in the gas phase will affect the treatments that can be used to capture these species.

In addition, the lower portion of fluidized bed furnaces typically have a reducing atmosphere (i.e. low oxygen, high carbon monoxide concentrations) as does the lower portion of a pulverized coal furnace. Ash fusion temperatures and eutectic temperatures are considerably lower under reducing atmosphere conditions compared to oxidizing conditions. For example, ash initial deformation temperatures under reducing conditions are 80° F. to 340° F. lower than under oxidizing conditions, depending on coal type.

Fluidized beds can also operate at significantly lower primary zone stoichiometries because the fluidized bed provides an inherently more stable combustion environment than a pulverized-coal burner. The air/fuel stoichiometry in the primary combustion zone in a pulverized-coal furnace is typically from about 0.7 to about 0.8 to sustain stable combustion, whereas the air/fuel stoichiometry in the primary zone of the fluidized bed furnace is typically less than 1 and in particular embodiments from about 0.4 to about 0.5.

Finally, in pulverized-coal combustion, additives and pulverized coal are co-fired and move co-currently through the combustion zone. The additive is free to tie up the alkali species without competition from other particles. However, in a fluidized bed, there is a considerable mass of bed material that could potentially tie up the additive or provide competing surface area that can react with the alkali species, thereby inhibiting the effectiveness of the additive. In this case, a higher stoichiometric ratio of additive could be required to achieve the same effect of trapping the reactive alkali species.

The present disclosure thus relates to systems and methods for controlling bed agglomeration in fluidized-bed boilers, which may occur when agricultural biomass fuels high in phosphorus and alkali content are used. Briefly, an iron-containing compound is added as an additive to the fluidized bed during combustion. Phosphorus released from the biomass reacts with the iron, forming iron-phosphorus alloys that are less reactive and have a much higher melting temperature than typical fluidized bed operating conditions. This also results in a net increase in the bed agglomeration temperature.

The iron-containing compound can generally be any iron compound that can undergo reduction in the combustion environment of the fluidized-bed boiler. These include iron (II) oxides; iron (III) oxides; iron (II) halides; iron (III) halides; iron (III) iodate; and iron (II) carbonates. Specific examples include Fe₂O₃; Fe₃O₄ (which can be written as FeO.Fe₂O₃); FeO, FeCO₃; FeBr₂; FeBr₃; FeCl₂; FeCl₃; and Fe(IO₃)₃. Any combination of these iron-containing compounds can also be used. Any of these iron-containing compounds can be used in a hydrated or non-hydrated form. It is noted that halides can be used to also control mercury emissions.

The one or more iron-containing compounds can be supplied in a powdered form, a solution form, an aqueous suspension form, or a combination thereof. The iron-containing compound should have a suitable particle size that facilitates a higher degree of reactivity. For example, about 95% of the particles have a particle size of less than about 400 μm (microns), a particle size of less than about 350 μm, a particle size of less than about 300 μm, a particle size of less than about 250 μm, a particle size of less than about 200 μm, or even a particle size of less than about 175 μm (microns).

The iron-containing compound(s) can be water soluble or water insoluble. In particular embodiments, water-soluble iron-containing compound(s) are added to the fluidized bed in the form of a solution. In other embodiments, water-insoluble iron-containing compound(s) can be added to the fluidized bed in the form of a suspension or emulsion.

The iron-containing compound(s) can be added/mixed together with the biomass fuel, and then added to the fluidized bed of the fluidized-bed boiler concurrently with the biomass. This would put the iron-containing compound(s) near the fuel as reactive species are released as vapor. In other embodiments, the iron-containing compound(s) can be injected into the fluidized bed through ports at a biomass fuel feed point, or through ports adjacent to a biomass fuel feed point. This will distribute the iron-containing compound(s) across the full plan area of the fluidized bed (along with the biomass fuel) to accommodate the latent release of vapor alkali components from char combustion. This also allows for more flexibility in the feed rate of the iron-containing compound(s), which can be adjusted independently from the biomass fuel feed rate. This allows for on-the-fly adjustment of iron-containing compound(s) if operating conditions in the fluidized bed change unexpectedly. In yet other embodiments, the iron-containing compound(s) can be injected into the bottom of the fluidized bed. This could be done by injection through the aeration nozzles (i.e. ducts 18 of FIG. 1) or through nozzles adjacent to the air aeration nozzles. This method would uniformly distribute the iron-containing powder throughout the fluidized bed.

The iron-containing compound(s) can be added to the fluidized bed in an amount of greater than zero and up to 12 wt % of the biomass fuel, including for example from 1 wt % to 8 wt %. Alternatively, the iron-containing compound(s) can be added to the fluidized bed in an amount of greater than zero and up to 3 moles per mole of (sodium oxides+potassium oxides+phosphorus oxides), including from about 0.25 mole to 3 moles or 0.25 to about 0.50 moles per mole (sodium oxides+potassium oxides+phosphorus oxides). More particularly, the iron-containing compound(s) can be added to the fluidized bed in an amount of greater than zero and up to 3 moles per mole of (Na₂O+K₂O+P₂O₅), including from about 0.25 mole to 3 moles or 0.25 to about 0.50 moles per mole of (Na₂O+K₂O+P₂O₅).

The iron-containing compound(s) can remove the gas phase phosphorus in the form of iron-phosphorus alloys which may or may not contain oxygen. Iron-bound phosphorus compounds are less leachable. An oxidized form of the iron-containing compound(s) is preferable; elemental iron is susceptible to carbon formation on the surface of the iron, which can inhibit phosphorus capture. Furthermore, phosphorus associated with and/or bound to an iron compound (e.g., an iron oxide) is more stable than phosphorus that is associated with and/or bound to a calcium compound (e.g., calcium oxide). This also substantially reduces the amount of calcium/phosphorus/oxygen-containing compounds, thereby freeing up the calcium compounds to react with SOₓ and reduce SOₓ emissions.

As a result of the addition of the iron-containing compounds, the bed agglomeration temperature can be increased by an amount of 5° C. to over 50° C. (9° F. to 90° F.) compared to baseline data (depending on the amount added).

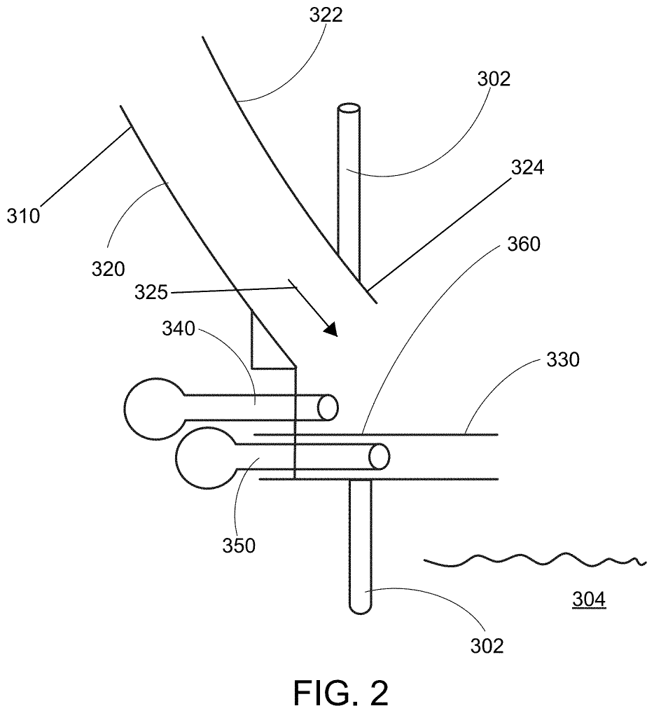

FIG. 2 is a side cross-sectional view of an illustrative embodiment of a dual-phase feeder 310 which may be useful in the present disclosure. The fuel feeder 310 passes through an opening formed in a furnace tube wall 302 which is illustrated for representational purposes with only one tube. Alternatively, the fuel feeder 310 may pass through a refractory (e.g. brick) furnace wall or other type of boiler wall. The fuel feeder 310 includes a sloped chute 320, a set of gas distribution nozzles 340, and a set of secondary ports 350. A plate 360 defines the base 330 of the fuel feeder 310. The sloped chute 320 has a top end 322 and a bottom end 324, the bottom end being proximate to the base 330 of the fuel feeder (i.e. plate). Solid fuel follows a solid feed path from the top end 322 to the bottom end 324 and into the boiler. Gas distribution nozzles 340 are located at the base 330 of the fuel feeder 310 and direct a gas into the solid feed path 325. The gas is usually air, though it could also be an oxygen-enriched or oxygen-depleted gas stream. The gas injected via the gas distribution nozzles 340 is used to distribute the biomass fuel fed through the chute 320 across the fluidized bed 304.

The secondary ports 350 illustrated here can be used to inject the iron-containing compound(s) into the fluidized bed. Here, the secondary ports 350 are located below the base 330, so that plate 360 separates the secondary ports 350 from the gas distribution nozzles 340. This reduces the effect of the gas injected by the gas distribution nozzles 340 on the dispersion of the iron-containing compound(s) injected by the secondary ports 350. These ports are “at” a biomass fuel feed point, where the biomass fuel would intersect the path that the iron-containing compound(s) would travel to the fluidized bed plan area. Ports are “adjacent” to a biomass fuel feed point if the biomass fuel and the iron-containing compound(s) would land in the same plan area, but their paths to the plan area would not intersect.

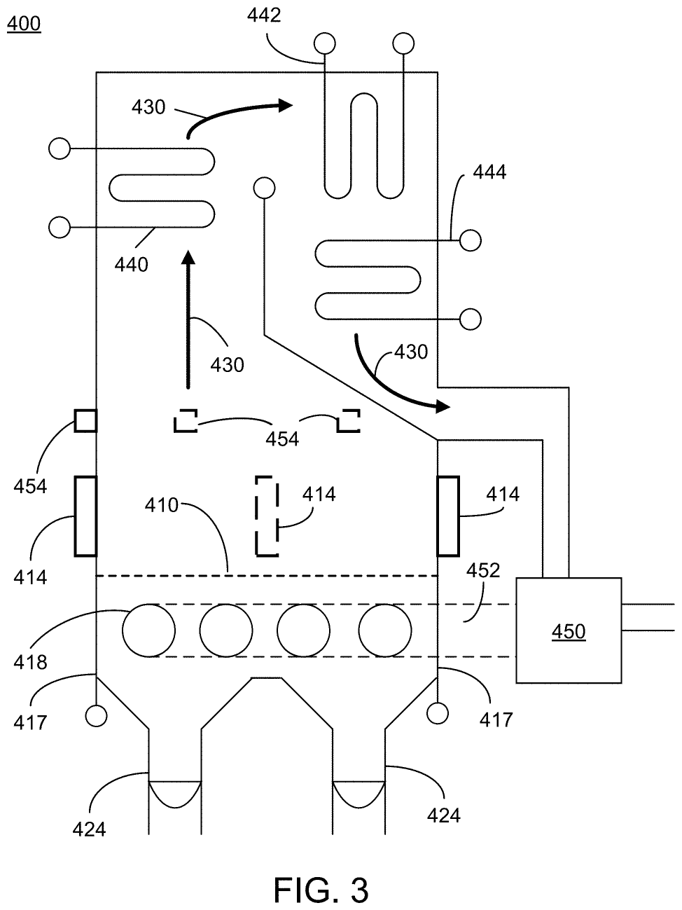

FIG. 3 is a schematic diagram of a fluidized-bed boiler 400 that is used to illustrate some aspects of the methods of operation of the present disclosure. Initially, the boiler includes a fluidized bed 410. The particles used to make up the fluidized bed can comprise, for example, silica (SiO₂), alumina (Al₂O₃), or limestone (CaCO₃). The fluidized bed is surrounded by water-cooled walls 417. Three fuel feeders 414 are illustrated for feeding fuel to the fluidized bed. Air ducts 418 provide the air for fluidizing the bed material, and bottom hoppers 424 are used for removing bed material for various purposes.

The fluidized bed is operated at a temperature of about 1200° F. to about 2000° F. (about 648° C. to about 1093° C.). The flue gas pathway is illustrated by dark arrows 430. Heat energy from the flue gas is captured via superheater 440, reheater 442, and economizer 444. The flue gas then passes through an air preheater 450. Flue gas exiting the boiler may be recirculated as the fluidizing medium of the fluidized bed if desired. As illustrated here, some of the flue gas passing through air preheater 450 can be redirected to the air ducts 418 via line/pipe 452. Flue gas recirculation can be used to control the intensity of fluidization and primary zone stoichiometry while maintaining the target temperature of the fluidized bed. Flue gas has a much lower oxygen concentration compared to air, and varying the ratios of flue gas/air in the fluidizing gas allows the bed temperature and the superficial bed velocity to be controlled over a wider range. It is essential to control bed temperature in a desired range to avoid agglomeration when firing fuels high in sodium and potassium. Severe agglomeration can occur at typical fluidized-bed temperatures of 1500° F. to 1600° F. By incorporating flue gas recirculation, it is possible to maintain the desired fluidizing gas velocity to promote good mixing and combustion while optimizing the total available oxygen to moderate combustion and lower the fluidized-bed temperature below the agglomeration temperature. The balance of required air to complete combustion is introduced through secondary air ports 454.

As described, the fluidized-bed temperature can be controlled. The fluidization intensity (e.g. bubbling bed vs. circulating bed) can also be controlled. These parameters aid in controlling the rate and size of any agglomerations that may be formed to an acceptable level that can be continuously removed with a bed material reclamation system.

The agglomerations can then be continuously removed during normal operation (e.g. via hoppers 424). Desirably, the total concentration of alkali species (Na+K) and phosphorus (P) within the fluidized bed should be less than 5% by weight Na+K+P. In alternate embodiments, the commercial bed drain rate can range from about 2.5% to about 10%. The bed drain rate refers to percent of the total mass of the fluidized bed material (shown as 10 in FIG. 1) that is drained every hour.

One technique for determining the onset of agglomeration within the fluidized bed is performed using high speed primary zone differential pressure measurements. The primary zone consists of the region of the fluidized-bed boiler below the over-fire air ports as indicated by reference numeral 454 in FIG. 3. The pressure drop across the fluidized bed of solids (410) is measured with high speed pressure transducer(s). The resultant signal is analyzed to identify a deviation from a Gaussian distribution of pressure fluctuations. The bed drain rate can then be adjusted to manage agglomeration formation while minimizing the addition of fresh bed material.

If the furnace wall and heating surface temperatures are maintained below 1000° F., acceptable slagging and fouling rates are obtained. Additional absorption surfaces (such as wing walls) can be incorporated into the boiler, or the residence time of the fuel can be adjusted, to ensure adequate burnout of the fuel while inhibiting slagging and fouling.

The present disclosure is further illustrated in the following non-limiting working examples. These examples are intended to be illustrative only, and the disclosure is not intended to be limited to the materials, conditions, process parameters and the like recited therein.

### Example 1

A bench-scale BFB facility was used for experimentation. The facility is composed of an electrically heated furnace and gas supply system. A set of mass flow controllers measures and controls the flow rate of fluidizing gases (O₂ and N₂) into the reactor. The reactor is composed of two concentric Inconel® tubes. Upon entering the reactor, the fluidizing gas flows downward in the reactor tube annulus and is preheated to the bed temperature. A porous frit for supporting the bed material distributes the fluidizing gas uniformly into the bed. The exhaust gas from the reactor is vented through a hood mounted on top of the furnace. The facility can be operated in either fixed bed or fluidized bed mode by varying the gas velocity. Solid fuel was batch fed by hand into the reactor from the top.

A K-type thermocouple was installed to monitor the bed temperature at about 4 inches from the bottom of the reactor's porous frit distributor. Inlet static pressure was monitored by a Validyne pressure transducer and the signal was acquired by a Flame Doctor® data acquisition system. The system has the capability to digitize and record analog signals at up to 500 Hz, and enables instant monitoring of the reactor conditions. During this project, data was acquired and analyzed in two-minute intervals. The output of the Validyne and the K-type thermocouple was also acquired by a National Instruments (NI) Data Acquisition Panel for continuous observation of bed operating conditions.

For the bench-scale testing, approximately 250 grams of high quartz silica sand bed material was charged to the reactor. The bed material was double screened using 40×45 mesh (420 μm×354 μm) screens (U.S.). The unit was started up with a furnace set point of 800° C. (at a ramp rate of 10° C./minute). This provided a 700° C. (1292° F.) bed temperature. This temperature was chosen to represent the low end of the target temperature range of a commercial operating system, and is also sufficiently low to inhibit any alkali-induced bed agglomeration during bed conditioning.

The gas flow of a mixture of air and nitrogen was adjusted to provide a 14% oxygen atmosphere in the bed. This corresponded to 6.2 standard liters per minute (SLPM) of air and 3.1 SLPM of nitrogen. At these conditions, the superficial velocity was approximately 5 times the minimum fluidizing velocity for this bed material at the operating temperature. Therefore, good fluidization was assured at this condition. To condition the bed, pellets of the blended fuel were added to the reactor one by one (semi-continuously) into the top of the reactor throughout the duration of the test period. The feed rate was adjusted to ensure sudden changes in bed temperature did not occur during bed conditioning. The total amount of fuel that was used during baseline conditioning tests (approximately 230 grams) was set as the standard for the subsequent tests that involved the use of additives. This is to ensure the total alkali input to bed remained approximately the same under all test conditions. The bed started showing de-fluidization effects in presence of phosphorus in the fuel along with less than 2 wt % alkali addition to the bed. Once the bed was conditioned with the required amount of fuel, a slow ramp test was carried out until the bed agglomerated. This was achieved by adjusting furnace temperature settings such that the bed temperature increased by 1° C./min. Conditions leading to agglomeration were continuously monitored and recorded.

The reactor was allowed to cool down and the inventory was weighed to record the total mass of bed material and ash. For most of the tests, the gain in weight (from an initial mass of 250 grams of sand) from fuel conditioning was anywhere between 15 grams and 20 grams. The bed material was then screened through a 12 mesh (U.S.) screen to quantify the amount of oversize/coarse materials from fuel conditioning. Later examination of the used bed material confirmed that there were no fused particles that were difficult to break apart with mild finger pressure. The coarse fraction was very friable and was hand crushed before reintroducing it back into the system. This was done to ensure that all alkali in the bed sample was accounted for during the agglomeration process including the ones that may have been present in the coarse size fraction. By breaking down the coarse sized particles to smaller bed sized material, the effect of bed de-fluidization from non-agglomeration effects was negated.

The nominal operating conditions in the bench-scale reactor are summarized below. It is noted that the fuel feed had a moisture content of 30% to 60%.

| | |
|---|---|
| Fuel feed | 67% lignin/33% syrup by weight |
| Fuel size | Double screened on ¼ inch × 4 (U.S.) |
| | mesh screens |
| Fuel moisture | Air dried at 34° C. (90° F.) overnight to 22% |
| Bed inventory | 250 grams of 40 mesh × 45 mesh high quartz |
| | sand |
| Bed temperature | 700° C. (1292° F.) |
| Oven ramp rate | 600° C./hour |
| Air flow | 6.2 SLPM |
| Nitrogen flow | 3.1 SLPM |
| Incoming gas oxygen | 13%-14% |
| concentration | |
| Superficial velocity | 5 times minimum fluidizing velocity |

Four data sets were obtained: (A) a baseline with no additives; (B) addition of 3 moles iron oxide per mole of oxides of (K+Na+P); (C) addition of 2 moles iron oxide per mole of oxides of (K+Na+P), and (D) addition of 1 mole iron oxide per mole of oxides of (K+Na+P),

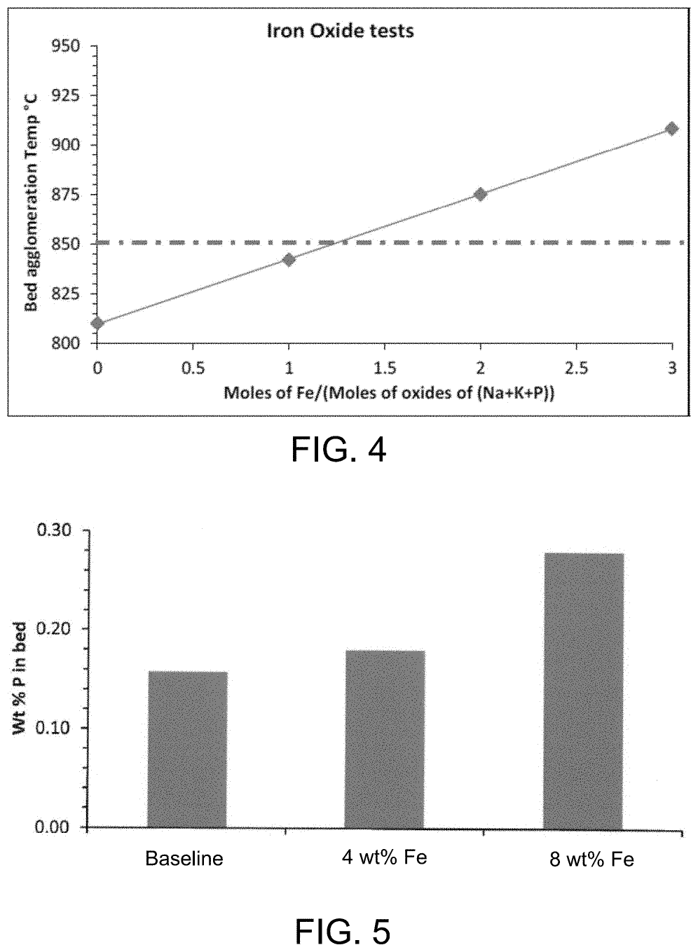

FIG. 4 shows the effect of iron oxide addition on bed agglomeration temperature. The dotted-dashed line indicates a preferred bed operating temperature for commercial operation. This graph indicates that addition of iron oxide increased bed agglomeration temperature from baseline conditions (represented by the 0 moles on the x-axis). The change in temperature is fairly linear with respect to iron oxide addition. It is noted that every 1 mole of iron oxide per mole of oxides of (K+Na+P) corresponded to approximately 4 wt % of iron oxide by weight of the fuel fed.

FIG. 5 is a bar graph showing the amount of phosphorus in bed ash samples. This indicates that gaseous phosphorus was captured in the bed itself by forming a higher melting point compound.

The present disclosure has been described with reference to exemplary embodiments. Modifications and alterations will occur to others upon reading and understanding the preceding detailed description. It is intended that the present disclosure be construed as including all such modifications and alterations insofar as they come within the scope of the appended claims or the equivalents thereof.

1. A method for reducing bed agglomeration in a fluidized-bed boiler when a biomass fuel is combusted, comprising:
adding at least one iron-containing compound to a fluidized bed of the fluidized-bed boiler.

2. The method of claim 1, wherein the at least one iron-containing compound is an iron (II) oxide; an iron (III) oxide; an iron (II) halide; an iron (III) halide; an iron (III) iodate; or an iron (II) carbonate.

3. The method of claim 1, wherein the at least one iron-containing compound is water soluble, and is added in the form of a solution.

4. The method of claim 1, wherein the at least one iron-containing compound is water insoluble, and is added in the form of a suspension or emulsion.

5. The method of claim 1, wherein the biomass fuel is corn stover, switch grass, miscanthus, or hybrid poplar.

6. The method of claim 1, wherein the fluidized-bed boiler operates at a temperature of about 1200° F. to about 2000° F. (about 648° C. to about 1093° C.).

7. The method of claim 1, wherein an air/fuel stoichiometry of the fluidized-bed boiler is about 0.4 to about 0.5.

8. The method of claim 1, wherein the at least one iron-containing compound is added to the fluidized bed in an amount of up to 12 wt % of the biomass fuel.

9. The method of claim 1, wherein the at least one iron-containing compound is added to the fluidized bed in an amount of up to 3 moles per mole of (sodium oxides+potassium oxides+phosphorus oxides).

10. The method of claim 1, wherein the at least one iron-containing compound is added to the fluidized bed in an amount of up to 3 moles per mole of (Na₂O+K₂O+P₂O₅).

11. The method of claim 1, wherein the at least one iron-containing compound is mixed together with the biomass fuel, and is added to the fluidized bed of the fluidized-bed boiler concurrently with the biomass fuel.

12. The method of claim 1, wherein the at least one iron-containing compound is injected through ports at or adjacent to a biomass fuel feed point.

13. The method of claim 1, wherein the at least one iron-containing compound is injected into a bottom of the fluidized bed.

14. The method of claim 1, wherein the biomass fuel has a moisture content of about 30% to about 60%.

15. The method of claim 1, wherein the fluidized bed comprises silica, alumina, or calcium.

16. The method of claim 1, wherein the fluidized bed is a kaolin containing fluidized bed and the iron-containing compound enhances the reactivity of the kaolin containing fluidized bed.
